(19) United States
(12) Patent Application Publication
(10) Pub. No.: US 2025/0310217 A1
(43) Pub. Date: Oct. 2, 2025

(54) METHOD AND APPARATUS FOR PROVIDING QOS POLICY ASSISTANCE INFORMATION AND PERFORMANCE MONITORING IN MOBILE COMMUNICATION SYSTEM

(71) Applicant: ELECTRONICS AND TELECOMMUNICATIONS RESEARCH INSTITUTE, Daejeon (KR)

(72) Inventors: Chang Sik LEE, Daejeon (KR); Seungjae SHIN, Daejeon (KR); Tae Yeon KIM, Daejeon (KR)

(73) Assignee: ELECTRONICS AND TELECOMMUNICATIONS RESEARCH INSTITUTE, Daejeon (KR)

(21) Appl. No.: 19/093,498

(22) Filed: Mar. 28, 2025

(30) Foreign Application Priority Data
Apr. 1, 2024 (KR) 10-2024-0044350
May 7, 2024 (KR) 10-2024-0059780
Jun. 11, 2024 (KR) 10-2024-0075515
Aug. 7, 2024 (KR) 10-2024-0105729
Aug. 12, 2024 (KR) 10-2024-0107536
Sep. 26, 2024 (KR) 10-2024-0131110
Oct. 11, 2024 (KR) 10-2024-0138645
Nov. 11, 2024 (KR) 10-2024-0159043
Nov. 27, 2024 (KR) 10-2024-0172055
Nov. 27, 2024 (KR) 10-2024-0172056
Feb. 20, 2025 (KR) 10-2025-0022129

(51) Int. Cl. H04L 41/5019

(52) U.S. Cl. CPC H04L 41/5019

(57) ABSTRACT

Various embodiments are disclosed regarding a technology for providing QoS policy assistance information and performance monitoring in a mobile communication system. In one embodiment, a method by which a first network node provides QoS (Quality of Service) policy assistance information may comprise: receiving a consumer request from a second network node; generating QoS policy assistance information based on the received consumer request; and providing the generated QoS policy assistance information to the second network node.

### CROSS REFERENCE TO RELATED APPLICATION

The present application claims priority to Korean Patent Application No. 10-2024-0044350, filed on Apr. 1, 2024, Korean Patent Application No. 10-2024-0059780, filed on May 7, 2024, Korean Patent Application No. 10-2024-0075515, filed on Jun. 11, 2024, Korean Patent Application No. 10-2024-0105729, filed on Aug. 7, 2024, Korean Patent Application No. 10-2024-0107536, filed on Aug. 12, 2024, Korean Patent Application No. 10-2024-0131110, filed on Sep. 26, 2024, Korean Patent Application No. 10-2024-0138645, filed on Oct. 11, 2024, Korean Patent Application No. 10-2024-0159043, filed on Nov. 11, 2024, Korean Patent Application No. 10-2024-0172055, filed on Nov. 27, 2024, Korean Patent Application No. 10-2024-0172056, filed on Nov. 27, 2024, and Korean Patent Application No. 10-2025-0022129, filed on Feb. 20, 2025, the entire contents of which are incorporated herein for all purposes by this reference.

### Background

### Technical Field

This disclosure relates to mobile communication system technology, and more specifically, certain embodiments relate to technologies for providing Quality of Service (QoS) policy assistance information and performance monitoring in the Network Data Analytics Function (NWDAF) of 5GS.

### Description of the Related Art

The 3GPP SA2 working group of the 3GPP which leads the mobile communication system market as the de facto standard, completed Stage 2 standardization of the 5G system Release 18 in the first half of 2023. Subsequently, after selecting Study Items for the standardization of Release 19, the group sequentially began studies for Release 19 starting in October 2023. In particular, the Study on Core Network Enhanced Support for Artificial Intelligence/Machine Learning (FS AIML CN) continues discussions on structural extensions for supporting AI services in the core network, following Release 18.

As of Release 18, the 5G core (hereinafter referred to as “5GC”) supports data-driven and AI/ML-based network automation and intelligence through the Network Data Analytics Function (NWDAF). NWDAF-based intelligence is centered on analytics with a focus on statistics or predictions, providing analytical information on various performance indicators, including Observed Service Experience Analytics, QoS Sustainability Analytics, Network Performance Analytics, and DN Performance Analytics. This analytical information can be requested and utilized by entities such as a PCF(Policy Control Function), an SMF (Session Management Function), an AMF (Access & Mobility Management Function), an NSSF (Network Slice Selection Function, or an OAM (Operation, Administration, and Management).

For example, a PCF collects data from other network functions (NFs) and requests the necessary analytical information from an NWDAF to determine QoS policies that meet the requirements of specific services. Based on the collected data and analytical information, the PCF updates the QoS policy and subsequently requests additional analytical information from the NWDAF to verify whether the updated QoS policy satisfies the service requirements. If the current QoS policy does not meet the service requirements, the PCF re-updates the QoS policy. Through this iterative process, the PCF determines the optimal QoS policy.

### SUMMARY

The present disclosure aims to provide improved mobile communication system technology (e.g., for efficiently determining an optimal QoS policy). The technical objectives intended to be achieved by the present disclosure are not limited to those mentioned above, and additional technical challenges not explicitly mentioned here may be considered by those skilled in the art to which the technical configuration of this disclosure applies, based on the embodiments described below.

One aspect of the present disclosure provides a method by which a first network node provides QoS (Quality of Service) policy assistance information. In some embodiments, the method may comprise: receiving a consumer request from a second network node; generating QoS policy assistance information based on the received consumer request; and providing the generated QoS policy assistance information to the second network node.

Another aspect of the present disclosure provides a method by which a second network node obtains QoS policy assistance information. In some embodiments, the method may comprise: sending a consumer request to a first network node to obtain QoS policy assistance information; and receiving QoS policy assistance information from the first network node.

Yet another aspect of this disclosure provides an electronic device (for example, a network node) that performs a method according to at least one of the embodiments of this disclosure. In some embodiments, the electronic device may comprise: a transceiver; a memory; and a processor electrically connected to the transceiver and the memory. In some embodiments, the processor may execute at least one instruction stored in the memory to cause the electronic device to perform a method according to at least one of the embodiments of this disclosure.

Yet another aspect of this disclosure provides a non-transitory recording medium storing instructions readable by a processor of an electronic device. In some embodiments, the instructions executed by the processor may cause the electronic device to perform a method according to at least one of the embodiments of this disclosure.

This summary is provided to introduce a selection of concepts in a simplified form that are further described in the detailed description below. This summary is not intended to identify key or essential features of the claimed subject matter, nor is it intended to be used to limit the scope of the claimed subject matter. The claimed subject matter is not limited to implementations that solve any or all disadvantages noted in any part of this disclosure. In addition to the exemplary aspects, embodiments, and features described above, further aspects, embodiments, and features will become apparent from the following detailed description and accompanying drawings.

Some embodiments of this disclosure may have an effect including the following advantages. However, since it is not meant that all exemplary embodiments should include all of them, the scope of the present disclosure should not be understood as being limited thereto.

According to some embodiments, techniques may be provided for efficiently performing conditional handover and conditional secondary cell change procedures in a wireless communication system.

According to some embodiments, improved mobile communication system technology (e.g., for efficiently determining an optimal QoS policy) may be provided.

### BRIEF DESCRIPTION OF THE DRAWINGS

FIG. 1 illustrates a procedure in which an NWDAF service consumer determines a QoS policy based on NWDAF analytics information in accordance with the 3GPP Release-18 specification.

FIG. 2 illustrates a procedure in which an NWDAF monitors the accuracy of analytics and provides analytics accuracy information in response to a consumer NF's request in accordance with the 3GPP Release-18 specification.

FIG. 3A illustrates a procedure in which an NWDAF registers a service profile with an NRF in accordance with the 3GPP Release-18 specification, and FIG. 3B illustrates a procedure in which another NF requests an NRF to discover an NWDAF capable of supporting a desired service in order to use NWDAF services in accordance with the 3GPP Release-18 specification.

FIG. 4A illustrates a procedure for registering an NWDAF profile with an NRF in accordance with some embodiments of the present disclosure, and FIG. 4B illustrates a procedure for discovering an NWDAF in accordance with some embodiments of the present disclosure.

FIG. 5 is a flowchart for explaining some embodiments that perform QoS policy assistance information provision and performance monitoring.

FIG. 6 illustrates input information that may be included when invoking a service for subscribing to or requesting analytics from an NWDAF.

FIG. 7 illustrates service-related data that an NWDAF may collect from an AF.

FIG. 8 illustrates QoS-related network data that an NWDAF may collect from a 5GC NF.

FIG. 9 illustrates QoS-related network data that an NWDAF may collect from an OAM.

FIG. 10 illustrates QoS policy assistance information provided by an NWDAF.

FIG. 11 is a block diagram illustrating an internal configuration of an electronic device (e.g., a network node) according to an embodiment of the present disclosure.

### DETAILED DESCRIPTION OF THE DISCLOSURE

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

Some embodiments of the present disclosure include technology for a control entity, such as a PCF, to subscribe to and request assistance information needed for determining QoS policy determination, from NWDAF, technology for the control entity to determine QoS policy and control the network based on the provided assistance information, and technology to support performance monitoring of the assistance information provided by NWDAF.

Additionally, some embodiments of the present disclosure include technology to introduce analytics necessary for NWDAF to provide QoS policy assistance information to the control entity, expand related service operations, and monitor analytics performance based on feedback information provided by the control entity and collected network data.

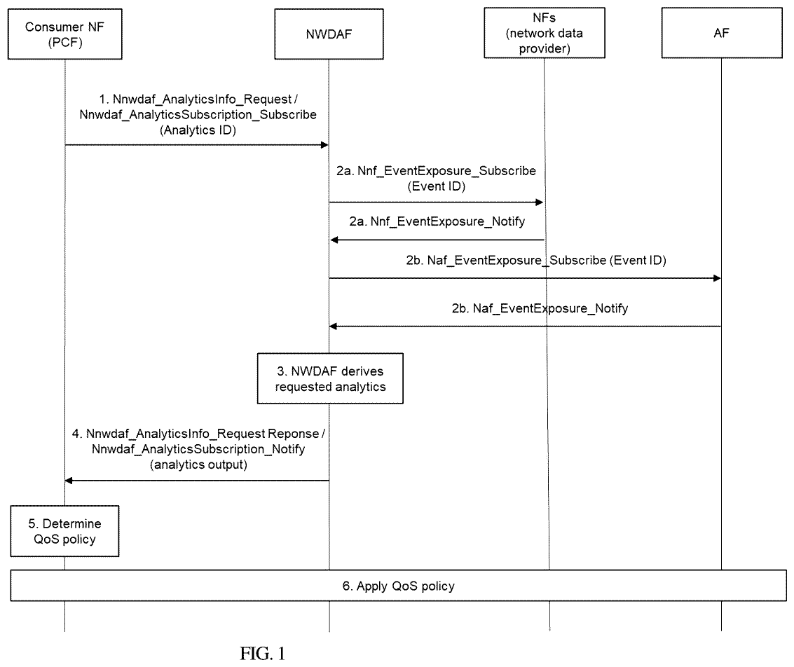

FIG. 1 illustrates a procedure in which an NWDAF service consumer determines a QoS policy based on NWDAF analytics information in accordance with the 3GPP Release-18 specification.

First, a PCF, as an NWDAF service consumer, subscribes to or requests analytics information (e.g., Observed Service Experience-related network data analytics, Network Performance Analytics, DN Performance Analytics, etc.) necessary for determining QoS policies from an NWDAF (Block 1).

The NWDAF collects the data required for the requested analytics from each data source (Blocks 2a, 2b) and derives the requested analytics information based on the collected data (Block 3).

Subsequently, the NWDAF provides the derived analytical results to the PCF (Block 4).

The PCF determines a QoS policy based on the received analytics information (Block 5) and applies the determined QoS to control the network (Block 6).

In the above-described technology, to determine whether the QoS policy the PCF has determined satisfies the service requirements of the application, the PCF requests updated analytics information from the NWDAF, and the NWDAF generates updated analytics information through data collection after the QoS policy has been updated and provides this information to the PCF. The PCF determines whether the service requirements are satisfied based on the updated analytical results, and if the service requirements are not satisfied, the PCF repeats the process of updating the QoS policy again, thereby finding the optimal QoS policy that can satisfy the service requirements.

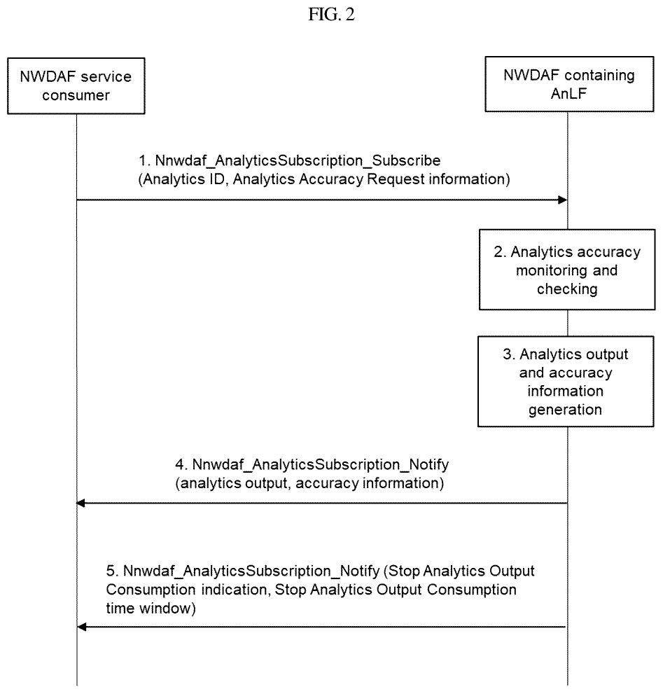

FIG. 2 illustrates a procedure in which an NWDAF monitors the accuracy of analytics and provides analytics accuracy information in response to a consumer NF's request in accordance with the 3GPP Release-18 specification.

The NWDAF service consumer may include analytics accuracy request information in the analytics subscription procedure (block 1). The NWDAF performs analytics accuracy monitoring after going through a verification procedure for the requested information (blocks 2 and 3). The NWDAF provides analytics accuracy information according to parameters included in the received analytics accuracy request information, either at specific intervals or when specific conditions are met (block 4).

The NWDAF service consumer may include an accuracy threshold in the analytics accuracy request information (block 1), and during the analytics accuracy monitoring process, if the analytics accuracy falls below the threshold, the NWDAF notifies the consumer by including a Stop Analytics Output Consumption indication and Stop Analytics Output Consumption time window (block 5).

The above procedure is described in the 3GPP TS23.288 document and is included for the purpose of understanding the present disclosure.

Meanwhile, according to the Release-18 specification, all NFs initially register with the NRF (Network Repository Function) regarding the service operations and capabilities that the NF can provide. The consumer NF discovers an NF that provides the service operations and capabilities it wishes to use from among the registered NFs through the NRF.

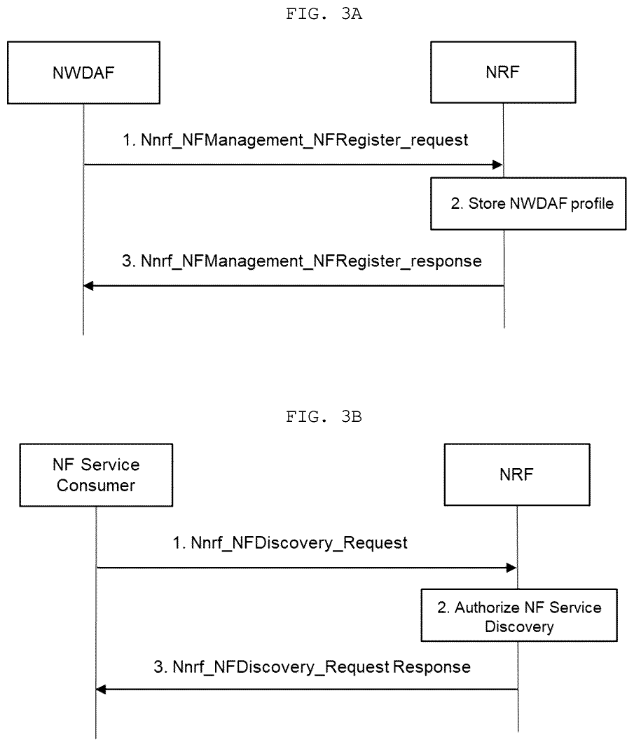

FIG. 3A illustrates a procedure in which an NWDAF registers a service profile with an NRF in accordance with the 3GPP Release-18 specification, and FIG. 3B illustrates a procedure in which another NF requests an NRF to discover an NWDAF capable of supporting a desired service in order to use NWDAF services in accordance with the 3GPP Release-18 specification. These procedures are described in the 3GPP TS23.502 document and are included for the purpose of understanding the present disclosure.

In SA2 Release-18, in the process of a PCF finding the optimal QoS policy, there may be inconvenience in having to repeatedly receive analytics information from an NWDAF to verify whether the current QoS satisfies service requirements. This may cause unnecessary signaling overhead between the PCF and the NWDAF, and may impose a significant load on the NWDAF in the process of deriving analytics information.

To solve these problems, some embodiments of the present disclosure provide technology that allows an NWDAF to provide QoS policy assistance information to a PCF based on request information received from the PCF, and allows the PCF to determine the optimal QoS policy based on information received from NWDAF.

Some embodiments of the present disclosure introduce analytics for an NWDAF to provide QoS policy assistance information to a control entity and provide an extension of related service operations. Additionally, some embodiments of the present disclosure provide performance monitoring technology for QoS policy assistance information provided by an NWDAF.

Furthermore, some embodiments of the present disclosure provide technology that allows a control entity (e.g., PCF) to efficiently determine QoS policy by providing QoS policy assistance information from an NWDAF in the 5GC to the control entity and through performance monitoring of this information.

Additionally, some embodiments of the present disclosure provide technology for a control entity in the 5GC to subscribe to or request QoS policy assistance information from an NWDAF in order to determine QoS policy, and to receive the requested information.

Also, some embodiments of the present disclosure provide technology to efficiently control a network through performance monitoring of QoS policy assistance information.

Moreover, some embodiments of the present disclosure provide technology enabling a control entity to determine the optimal QoS policy that can satisfy application service requirements and perform network control using the QoS policy assistance information provided.

According to the system illustrated in FIGS. 1 and 2, a control entity (e.g., a PCF) determines a QoS policy based on analytics provided by an NWDAF, verifies whether the current or future service experience satisfies the service requirements, and, if not, repeatedly updates the QoS policy.

However, such repeated procedures may impose excessive overhead on the 5GC. To address this issue, in some embodiments, an NWDAF may provide QoS policy assistance information to a control entity, including candidate QoS parameters and predicted service experience.

In some embodiments, an NWDAF may be equipped with a QoS and policy assistance capability. For example, this capability may include an ability that can assist in QoS and policy determination, an ability to provide candidate QoS parameters and/or an ability to recommend new QoS policies.

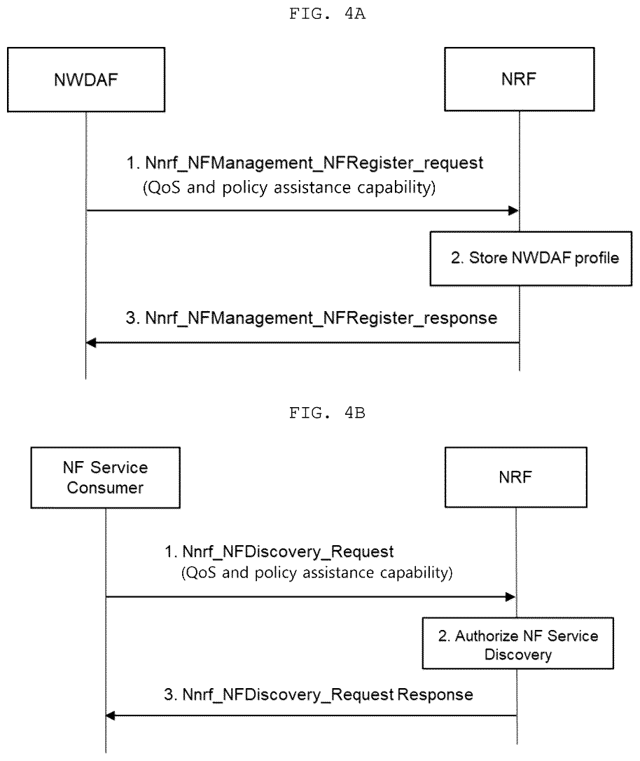

In some embodiments, as illustrated later in FIG. 4A, an NWDAF may include this capability (e.g., the QoS and policy assistance capability) in its profile during an NRF registration procedure. In some embodiments, a subsequent consumer NF may, as illustrated later in FIG. 4B, request the discovery of an NWDAF that supports this capability from the NRF if subscription to the NWDAF's service is required. The consumer NF may then discover, select, and receive related services from an appropriate NWDAF.

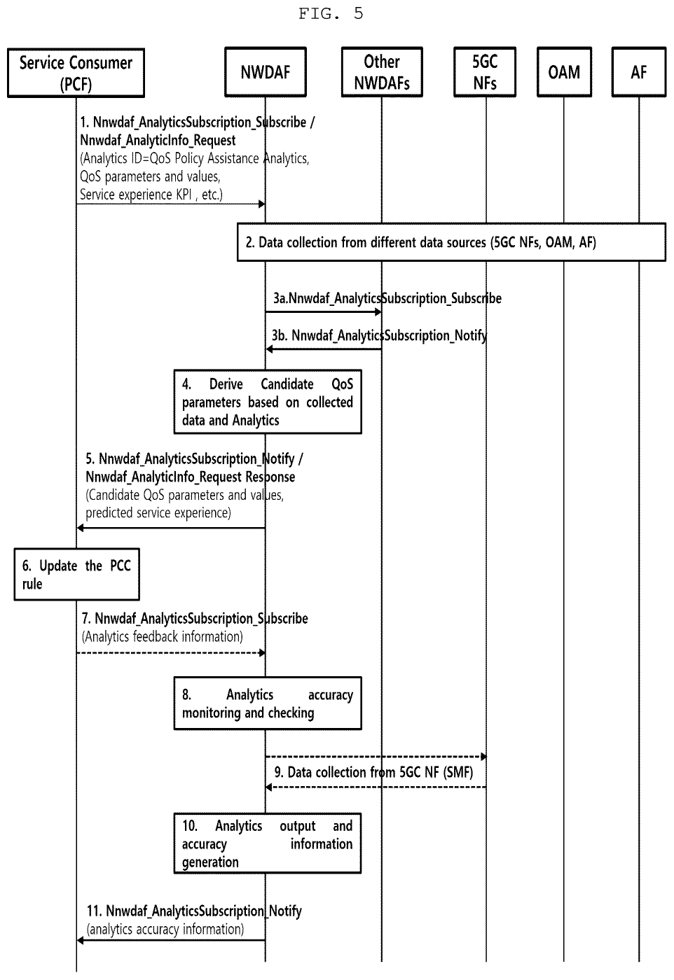

In some embodiments of the present disclosure, as illustrated later in FIG. 5, a procedure is provided in which an NWDAF provides QoS policy assistance information to a control entity upon its request, thereby introducing new analytics and extending existing service operations.

In some embodiments, a method by which a first network node provides QoS policy assistance information, may comprise: receiving a consumer request from a second network node; generating QoS policy assistance information based on the received consumer request; and providing the generated QoS policy assistance information to the second network node. For example, the first network node comprises a NWDAF of a mobile communication system, and the second network node comprises a PCF of a mobile communication system.

In some embodiments, receiving the consumer request may comprise receiving, from the second network node, input values necessary to obtain the QoS policy assistance information.

In some embodiments, receiving the consumer request may comprise the second network node requesting or subscribing to QoS and policy assistance analytics from the first network node.

In some embodiments, generating the QoS policy assistance information may comprises collecting information based on the received consumer request; and generating the QoS policy assistance information based on the collected information.

In some embodiments, the collected information may comprise at least one of data collected from a data source of the mobile communication system or analytics information collected from a NWDAF of the mobile communication system.

In some embodiments, the data source may comprise at least one of other network functions, AF (Application Function), or OAM (Operations, Administration, and Maintenance).

For example, the other network functions may comprise at least one of an SMF (Session Management Function), AMF (Access and Mobility Management Function), or UPF (User Plane Function), and the collected information may comprise at least one of Timestamp, UE ID (identifier), UE Location, DNN (Data Network Name), S-NSSAI, Application ID, IP filter information, QFI (QoS Flow Identifier), 5QI, QoS characteristic attributes, QoS flow Bit Rate, or QoS flow Packet Delay.

In some embodiments, the collected information may further comprise at least one of MFBR (Maximum Flow Bit Rate), GFBR (Guaranteed Flow Bit Rate), AMBR (Aggregate Maximum Bit Rate), or MPLR (Maximum Packet Loss Rate).

In some embodiments, the collected information may comprise at least one of Observed Service Experience Analytics, QoS Sustainability Analytics, or Network Performance Analytics.

In some embodiments, the collected information may comprise at least one of Reference Signal Received Power, Reference Signal Received Quality, Signal-to-noise and interference ratio, average DL/UL UE throughput in a gNB, RAN part delay for DL/UL, or RAN packet loss rate for DL/UL.

In some embodiments, the collected information may comprise input data for observed service experience-related network data analytics.

In some embodiments, the collected analytics information may comprise at least one of Observed Service Experience Analytics, QoS Sustainability Analytics, or Network Performance Analytics.

In some embodiments, the generated QoS policy assistance information may comprise at least one of UE ID, IP filter information, Analytics filter Information, at least one candidate QoS parameter set, or predicted performance for each of the at least one candidate QoS parameter set.

In some embodiments, receiving the consumer request may comprise receiving information regarding a maximum number of objects from the second network node, and the number of candidate QoS parameter sets may be limited by the received maximum number of objects.

In some embodiments, each candidate QoS parameter set may comprise a predefined 5QI value or the QoS characteristic attributes constituting the 5QI.

In some embodiments, the QoS characteristic attributes may comprise at least one of resource type, priority level, packet delay budget, packet error rate, averaging window, or maximum data burst volume.

In some embodiments, each candidate QoS parameter set may further include at least one of MFBR, GFBR, AMBR, or MPLR.

In some embodiments, each candidate QoS parameter set may further include at least one of MBR (Maximum Bit Rate) or GBR (Guaranteed Bit Rate).

In some embodiments, each QoS parameter value included in a candidate QoS parameter set may be a value belonging to a list of candidate values provided by the second network node.

In some embodiments, the predicted performance may comprise the value of the service experience expected when the candidate QoS parameter set is applied. In some embodiments, the service experience value may comprise an observed Service MoS (Mean Opinion Score). In some embodiments, the predicted performance may further comprise the average, variance, maximum, and minimum values of QoE (Quality of Experience) performance.

In some embodiments, a method by which a second network node obtains QoS policy assistance information may comprise sending a consumer request to a first network node to obtain QoS policy assistance information; and receiving QoS policy assistance information from the first network node.

In some embodiments, the second network node may comprise a PCF of a mobile communication system, and the method may further comprise updating a PCC (Policy and Charging Control) rule based on the received QoS policy assistance information.

In some embodiments, the first network node may comprise a NWDAF of a mobile communication system, and sending the consumer request may comprise invoking a service operation for analytics subscription or analytics information request provided by the NWDAF.

In some embodiments, invoking the service operation may comprise invoking the service operation with at least one of Analytics ID, at least one QoS parameter set, a list of candidate values for individual QoS parameters, analytics filter information, Analytics target period, or Target of Analytics Reporting.

In some embodiments, the Analytics ID may be “QoS Policy Assistance Information” or “QoS and Policy Assistance.” In some embodiments, invoking the service operation may comprise invoking the service operation further with at least one of service experience KPI, a reference value of the service experience KPI, preferred order of results, maximum number of objects, or preferred level of accuracy of the analytics. For example, the service experience KPI may include an observed Service MoS, which serves as the performance metric that the second network function targets when determining the QoS policy. In another example, the service experience KPI may further include various QoE.

In some embodiments, the reference value of the service experience KPI may be expressed as at least one of requested QoE, Thresholds for service experience KPI, or target service experience.

In some embodiments, the preferred order of results may comprise information for sorting the QoS policy assistance information. In some embodiments, the information for sorting the QoS policy assistance information may comprise an ordering criterion. In some embodiments, the ordering criterion may comprise service experience KPI or QoE.

In some embodiments, the maximum number of objects may be a value that limits the number of candidate QoS parameter sets included in the QoS policy assistance information.

In some embodiments, each of the QoS parameter sets may comprise a predefined 5QI value or the QoS characteristic attributes constituting the 5QI.

In some embodiments, the QoS characteristic attributes may include at least one of resource type, priority level, packet delay budget, packet error rate, averaging window, or maximum data burst volume.

In some embodiments, each QoS parameter set may further comprise at least one of MFBR, GFBR, AMBR, or MPLR. In some embodiments, each QoS parameter set may further comprise at least one of MBR or GBR.

In some embodiments, the analytics filter information may include at least one of Area of Interest (AOI), DNN, S-NSSAI (Single—Network Slice Selection Assistance Information), and Application ID.

In some embodiments, a second network node (e.g., a control entity such as a PCF) may update the QoS policy by referring to the QoS parameter combination (e.g., a candidate QoS parameter set) and the predicted service experience value (e.g., performance metric value) provided by a first network node (e.g., an NWDAF), and may provide analytics feedback regarding the utilization of the QoS parameter combination to the NWDAF.

In some embodiments, if the first network node receives analytics feedback from the second network node or if the second network node requests analytics accuracy information, the first network node may perform performance monitoring of the analytics. For example, for performance monitoring, the first network node may collect network data from 5GC network functions, including the SMF, to verify whether the QoS parameters included in the QoS policy assistance information were actually used in the QoS policy. If the QoS parameters were actually used, the NWDAF may collect the service experience value (e.g., the measured performance metric value) and compare it with the predicted service experience value (e.g., the predicted performance metric value) to calculate an accuracy. If the calculated accuracy does not satisfy a certain threshold, the first network node may provide a warning alert to the second network node. The second network node may then update the QoS policy based on the alert to achieve optimal network control.

FIG. 4A illustrates a procedure for registering an NWDAF profile with an NRF in accordance with some embodiments of the present disclosure, and FIG. 4B illustrates a procedure for discovering an NWDAF in accordance with some embodiments of the present disclosure.

Referring to FIG. 4A, in some embodiments, if the NWDAF supports QoS and policy assistance capability during the NWDAF profile registration procedure between the NWDAF and the NRF, the NWDAF may register an NWDAF profile with the NRF that includes, in addition to the information included in conventional NWDAF profile registration (e.g., information specified in 3GPP TS23.501 or 3GPP TS23.502), the QoS and policy assistance capability (Block 1).

In some embodiments, the QoS and policy assistance capability of the NWDAF may be a capability of providing information needed by a consumer NF in determining QoS policy. For example, the QoS and policy assistance capability of the NWDAF may include the capability to provide a candidate combination (e.g., QoS parameters and values obtained by selecting all or part of the available QoS parameter sets) selected from combinations of available QoS parameter sets (e.g., at least one QoS parameter set provided from the consumer NF) or the capability to recommend new QoS parameters and values.

Subsequently, the NRF stores the NWDAF profile information (Block 2) and may deliver the registration result to the NWDAF (Block 3).

Referring to FIG. 4B, following the NRF registration procedure according to FIG. 4A, in some embodiments, when another consumer NF wishes to discover an NWDAF that can assist with QoS and policy determination (e.g., an NWDAF equipped with the QoS and policy assistance capability), the consumer NF may request discovery by including the QoS and policy assistance capability, in addition to the information included in conventional discovery procedures (e.g., information specified in 3GPP TS23.501 or 3GPP TS23.502) (Block 1).

Subsequently, the NRF discovers an NWDAF supporting the QoS and policy assistance capability from among the plurality of registered NWDAFs (Block 2) and may send the corresponding results to the consumer NF (Block 3).

FIG. 5 is a flowchart for illustrating some embodiments for providing QoS policy assistance information and performing performance monitoring.

In some embodiments, a consumer NF may determine a QoS policy using the QoS policy assistance information provided by NWDAF, in accordance with its internal logic or operator policies. For convenience, the embodiments illustrated in FIG. 5 focus on the case where the consumer NF is a PCF; however, the same principles may also apply to embodiments where the consumer NF comprises an entity other than a PCF (e.g., AF, OAM, or another 5GC NF).

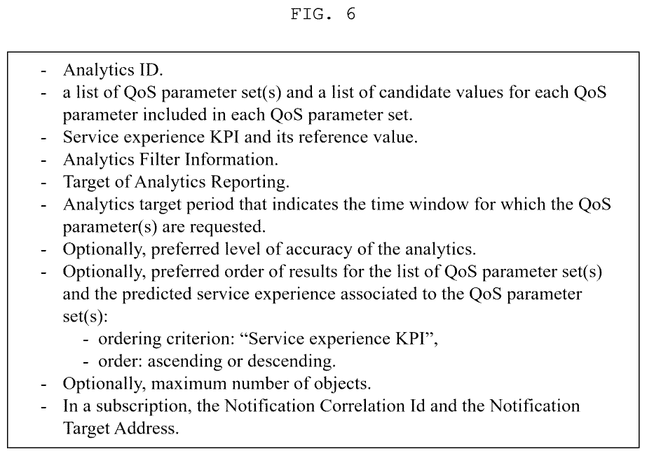

Referring to FIG. 5, the PCF may subscribe to or request analytics from the NWDAF to receive the QoS policy assistance information. For example, the PCF may invoke a service operation corresponding to Nnwdaf AnalyticsSubscription Subscribe or Nnwdaf_AnalyticsInfo_Request. The invocation of such service operations may include all or part of the information set forth in FIG. 6.

FIG. 6 illustrates input information that may be included when invoking a service for subscribing to or requesting analytics from an NWDAF.

In one exemplary embodiment, the analytics identifier may be “QoS Policy Assistance Information.” In another embodiment, the analytics identifier may be “QoS and Policy Assistance.” In some embodiments, each QoS parameter set may include a pre-defined 5QI value or QoS characteristic attributes that comprise the 5QI. The QoS characteristic attributes may include, at least one of the following: Resource Type, Priority Level, Packet Delay Budget, Packet Error Rate, Averaging Window, or Maximum Data Burst Volume.

In some embodiments, each QoS parameter set may additionally include at least one of MFBR, GFBR, AMBR, or MPLR. In further embodiments, each QoS parameter set may also include at least one of MBR or GBR.

In some embodiments, the list of candidate values for an individual QoS parameter may comprise either a single value or multiple values. For instance, if the NWDAF provides the PCF with a list of candidate values for an individual QoS parameter, the NWDAF may generate a candidate QoS parameter set from the provided list of parameter candidate values. In another example, if a candidate value for a specific parameter is not provided by the PCF, the NWDAF may independently derive a value for that parameter.

In some embodiments, the service experience KPI may be a service experience performance indicator targeted by the PCF in determining a QoS policy, and it may include various QoEs in addition to the observed Service MoS.

In some embodiments, a reference value for the service experience KPI may be expressed as at least one of the following: a requested QoE, thresholds for the service experience KPI, or a target service experience. For example, if the PCF provides a reference value for the service experience KPI, the NWDAF may derive a QoS parameter set that is predicted to achieve a service experience KPI above the reference value, from among the available QoS parameter combinations.

In some embodiments, the analytics filter information may include at least one of the following: an Area of Interest (AOI), a DNN, an S-NSSAI (Single—Network Slice Selection Assistance Information), or an Application ID.

In some embodiments, the preferred result order is information used for sorting the QoS policy assistance information, which may include a sorting criterion and/or a sorting order (ascending or descending). For example, the sorting criterion may include the service experience KPI. In another example, the sorting criterion may include QoE. If the PCF provides a sorting criterion, the NWDAF may provide the QoS policy assistance information to the PCF sorted in either ascending or descending order based on the provided sorting criterion.

In some embodiments, the maximum number of objects may limit the number of candidate QoS parameter sets included in the QoS policy assistance information. For example, if the PCF provides the maximum number of objects, the QoS policy assistance information provided by the NWDAF may include up to that maximum number of candidate QoS parameter sets.

Referring again to FIG. 5, in some embodiments, upon receiving an analytics subscribe or request service invocation from the PCF, the NWDAF may collect necessary data from data sources such as other 5GC NFs, AF (Application Function), or OAM (Operations, Administration, and Maintenance) to generate the QoS policy assistance information (block 2).

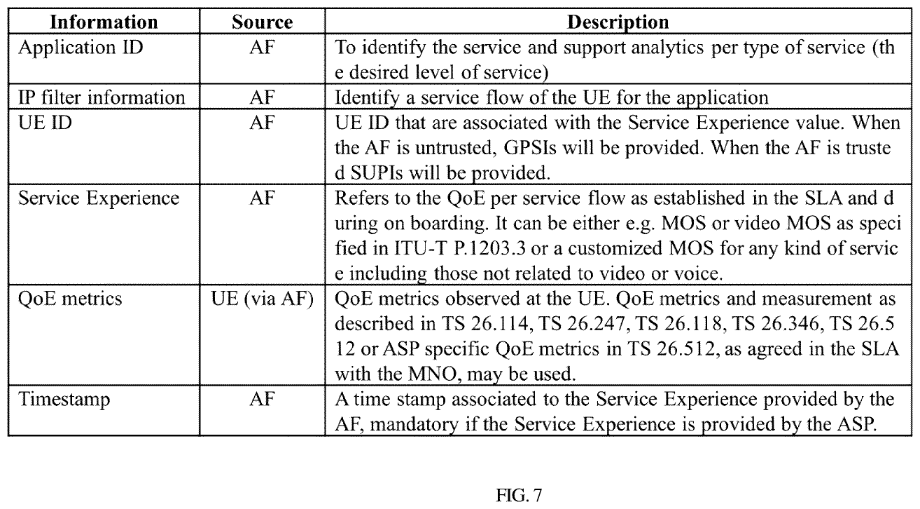

For example, in order for the NWDAF to generate the QoS policy assistance information, it may collect service-related data from an AF, and this service-related data may include at least one of the information illustrated in FIG. 7. FIG. 7 illustrates service-related data that an NWDAF may collect from an AF.

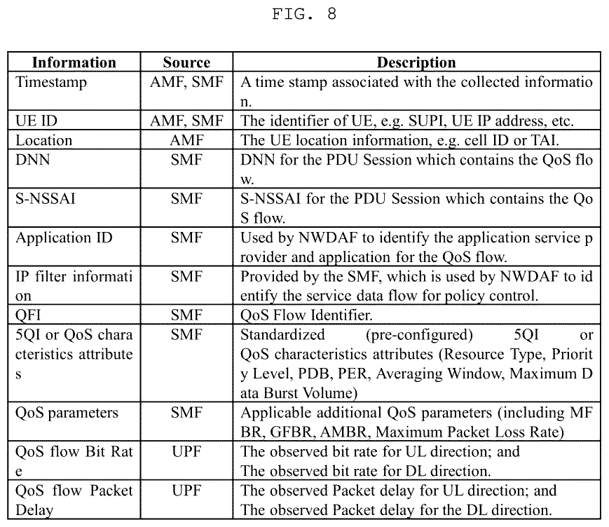

In another embodiment, the NWDAF may collect QoS-related network data from a 5GC NF to generate the QoS policy assistance information, and such QoS-related network data may include at least one of the information illustrated in FIG. 8. FIG. 8 illustrates QoS-related network data that an NWDAF may collect from a 5GC NF.

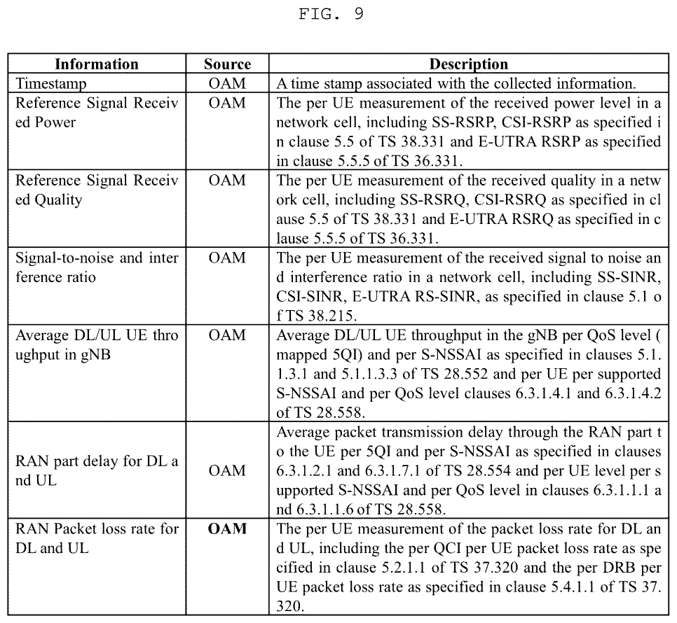

In yet another embodiment, the NWDAF may collect QoS-related network data from OAM to generate the QoS policy assistance information, and such data may include at least one of the information illustrated in FIG. 9. FIG. 9 illustrates a QoS-related network data that an NWDAF may collect from an OAM.

Furthermore, in addition to the aforementioned data, the NWDAF may collect input data for Observed Service Experience related network data analytics, as defined in the 3GPP TS23.288 document, from an AF, OAM, or a 5GC NF.

Referring again to FIG. 5, in some embodiments, upon receiving an analytics subscribe or request service invocation from the PCF, the NWDAF may collect analytics from other NWDAFs (block 3). For example, the analytics collected from other NWDAFs may include at least one of the Observed Service Experience Analytics, QoS Sustainability Analytics, or Network Performance Analytics.

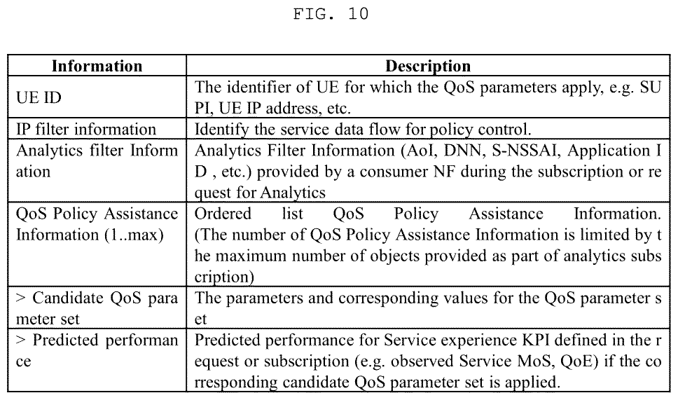

Still referring to FIG. 5, in some embodiments, the NWDAF may generate the QoS policy assistance information based on the collected data and/or analytics (block 4). For example, the QoS policy assistance information may include at least one of the information illustrated in FIG. 10.

FIG. 10 illustrates QoS policy assistance information provided by an NWDAF.

In some embodiments, as illustrated in FIG. 10, the QoS policy assistance information provided by the NWDAF may include at least one of the following: a UE identifier (UE ID), IP filter information, analytics filter information, at least one candidate QoS parameter set, or the predicted performance for each of the candidate QoS parameter sets. As described above, the number of candidate QoS parameter sets that the NWDAF can provide may be limited by the maximum number of objects provided by the PCF.

In some embodiments, each candidate QoS parameter set provided by the NWDAF may include a predefined 5QI value or the QoS characteristic attributes that constitute the 5QI. The QoS characteristic attributes that constitute the 5QI may include at least one of the following: Resource Type, Priority Level, Packet Delay Budget, Packet Error Rate, Averaging Window, or Maximum Data Burst Volume. In some embodiments, each candidate QoS parameter set may further include at least one of MFBR, GFBR, AMBR, or MPLR. In other embodiments, each candidate QoS parameter set may additionally include at least one of MBR (Maximum Bit Rate) or GBR (Guaranteed Bit Rate).

In some embodiments, the individual QoS parameter values of the candidate QoS parameter sets may be values belonging to a list of candidate values provided by the PCF.

In some embodiments, the predicted performance provided by the NWDAF may be the expected service experience value when the candidate QoS parameter set is applied and may include average, variance, maximum, minimum values, etc. for various QoE performances in addition to observed Service MoS. If the PCF provides a reference value for the service experience KPI during the analytics subscribe or request (e.g., as in block 1 of FIG. 5), the NWDAF may generate QoS policy assistance information including QoS parameter sets predicted to achieve at least the reference value of service experience KPI from among available QoS parameter combinations and the predicted performance of those QoS parameter sets.

Referring again to FIG. 5, in some embodiments, the NWDAF may provide the generated QoS policy assistance information to the service-consuming PCF (block 5).

In some embodiments, based on the received QoS policy assistance information, the PCF may update the PCC rules by selecting the optimal QoS parameters according to its internal logic (block 6). The PCF may choose all, some, or none of the QoS parameter sets provided by the NWDAF, based on its internal logic.

In some embodiments, if the PCF selects one or more QoS parameter sets provided by the NWDAF during the PCC rule update process, the PCF may include information on the used QoS parameter sets in analytics feedback information and send such feedback to the NWDAF (block 7).

In some embodiments, if the NWDAF receives the aforementioned analytics feedback information from the PCF, or if the PCF includes Accuracy Request Information during the QoS policy assistance analytics subscribe or request process (e.g., as in block 1 of FIG. 5), the NWDAF may perform analytics accuracy monitoring and checking procedures (block 8). For example, the information on the QoS parameter set included in the Accuracy Request Information should be identical to the QoS parameter set information provided during the QoS policy assistance analytics subscribe or request process.

In some embodiments, the NWDAF may collect data regarding the used QoS parameters from a 5GC NF, including the SMF (block 9), because in order to calculate the accuracy of the QoS policy assistance information, it is necessary to determine whether the QoS parameter sets included in the QoS policy assistance information were actually used. In other words, based on the collected used QoS parameter data, the NWDAF may determine whether the QoS parameter sets in the QoS policy assistance information were actually used.

In some embodiments, based on the collected used QoS parameter data, the NWDAF may calculate the analytics accuracy (block 10). For example, if a candidate QoS parameter set included in the QoS policy assistance information is actually used, the NWDAF may collect the actual service experience value, treat it as ground truth data, and calculate the analytics accuracy based on the difference between the predicted service experience value included in the QoS policy assistance information and the actual service experience value (block 10).

In some embodiments, the NWDAF may provide the calculated analytics accuracy information to the PCF (block 11). For example, the analytics accuracy information may be provided in accordance with the method specified in the analytics request information provided by the PCF. As another example, the analytics accuracy information may be provided periodically. As yet another example, the analytics accuracy information may be provided when certain conditions are met. For instance, if the actual service experience value is lower than a predefined threshold or if the difference between the predicted and actual values for service experience exceeds a predefined threshold, an alert message may be sent to the PCF. In this case, the alert message may include information such as a Stop Analytics Output Consumption indication and a Stop Analytics Output Consumption time window.

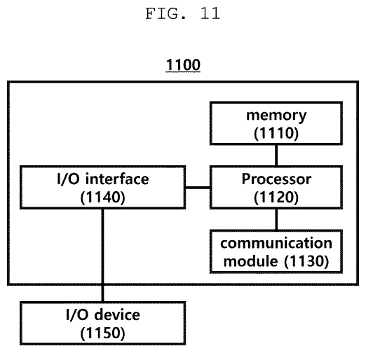

FIG. 11 is a block diagram illustrating an internal configuration of an electronic device (e.g., a network node) according to an embodiment of the present disclosure. In FIG. 11, electronic device 1100 is described as a single physical device, but depending on the embodiment, electronic device 1100 may be implemented as a plurality of devices operating in cooperation (e.g., distributed computing). In some embodiments, electronic device 1100 may include a memory 1110, a processor 1120, and a communication module 1130, as shown in FIG. 11. In some other embodiments, electronic device 1100 may further include an input/output interface 1140, and all or some of other units (e.g., input/output device 1150).

The memory (1110) may be a computer-readable recording medium and may include a RAM (random access memory), a ROM (read only memory), and a non-volatile mass storage device such as a disk drive. Here, the ROM and the non-volatile mass storage devices may be included as separate permanent storage devices apart from the memory (1110). Additionally, the memory (1110) may store an operating system and at least one program code (e.g., a computer program stored on the recording medium included in the electronic device (1100) to control the electronic device (1100) to perform methods according to embodiments of the present disclosure). These software components may be loaded from a computer-readable recording medium separate from the memory (1110). This separate computer-readable recording medium may include floppy drives, disks, tapes, DVD/CD-ROM drives, memory cards, and other computer-readable recording media. In other embodiments, the software components may be loaded into the memory (1110) via the communication module (1130) instead of a computer-readable recording medium.

The processor (1120) may be configured to process instructions of a computer program by performing basic arithmetic, logic, and input/output operations. The instructions may be provided to the processor (1120) by the memory (1110) or the communication module (1130). For example, the processor (1120) may be configured to execute the instructions received according to the program code loaded into the memory (1110). As a more specific example, the processor (1120) can sequentially execute instructions according to the code of a computer program loaded in the memory (1110) to perform beam configuration and/or RIS control according to the embodiments of the present disclosure.

The communication module (1130) may provide functions for communicating with other physical devices over an actual computer network. For example, while the processor (1120) of the electronic device (1100) performs part of the process of the present embodiment, another physical device in the network (e.g., another computing system not shown) can perform the remaining process, and the processing results may be exchanged via the computer network and the communication module (1130) to perform the embodiments of the present disclosure.

The input/output interface (1140) may serve as a means for interfacing with input/output devices (1150). For example, input devices in the input/output devices (1150) may include devices such as a keyboard or a mouse, and output devices may include devices such as a display or speakers. In FIG. 11, the input/output devices (1150) are represented as separate devices from the electronic device (1100), but in some embodiments, the electronic device (1100) may be implemented to include the input/output devices (1150).

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method by which a first network node provides QoS (Quality of Service) policy assistance information, comprising:
receiving a consumer request from a second network node;
generating QoS policy assistance information based on the received consumer request; and
providing the generated QoS policy assistance information to the second network node.

2. The method of claim 1, wherein generating the QoS policy assistance information comprises:
collecting information based on the received consumer request; and
generating the QoS policy assistance information based on the collected information.

3. The method of claim 1, wherein the first network node comprises a NWDAF (Network Data Analytics Function) of a mobile communication system.

4. The method of claim 1, wherein the second network node comprises a PCF (Policy Control Function) of a mobile communication system.

5. The method of claim 1, wherein receiving the consumer request comprises receiving, from the second network node, input information necessary to obtain the QoS policy assistance information.

6. The method of claim 2, wherein the collected information comprises at least one of data collected from a data source of a mobile communication system or analytics information collected from an NWDAF of the mobile communication system.

7. The method of claim 6, wherein the data source comprises at least one of other network functions, an AF (Application Function), or an QAM (Operations, Administration, and Maintenance).

8. The method of claim 7, wherein:
the other network functions comprise at least one of an SMF (Session Management Function), an AMF (Access and Mobility Management Function), or a UPF (User Plane Function), and
the collected information comprises at least one of Timestamp, UE ID (identifier), UE Location, DNN (Data Network Name), S-NSSAI, Application ID, IP filter information, QFI (QoS Flow Identifier), 5QI, or QoS characteristic attributes.

9. The method of claim 8, wherein the collected information further comprises at least one of MFBR (Maximum Flow Bit Rate), GFBR (Guaranteed Flow Bit Rate), AMBR (Aggregate Maximum Bit Rate), or MPLR (Maximum Packet Loss Rate).

10. The method of claim 6, wherein the collected analytics information comprises at least one of Observed Service Experience Analytics, QoS Sustainability Analytics, or Network Performance Analytics.

11. The method of claim 1, wherein the generated QoS policy assistance information comprises at least one of UE ID, IP filter information, Analytics filter Information, at least one candidate QoS parameter set, or predicted performance for each of the at least one candidate QoS parameter set.

12. The method of claim 11, wherein each of the at least one candidate QoS parameter set comprises a predefined 5QI value or QoS characteristics attributes constituting 5QI.

13. The method of claim 12, wherein each of the at least one candidate QoS parameter set further comprises at least one of MFBR, MBR (Maximum Bit Rate), GFBR, GBR (Guaranteed Bit Rate), AMBR, or MPLR.

14. The method of claim 1, wherein:
receiving the consumer request comprises receiving a reference value of a service experience KPI, and
generating the QoS policy assistance information comprises deriving QoS parameter combinations predicted to achieve at least the reference value of the service experience KPI from among available QoS parameter combinations.

15. A method by which a second network node obtains QoS policy assistance information, comprising:
sending a consumer request to a first network node to obtain QoS policy assistance information; and
receiving QoS policy assistance information from the first network node.

16. The method of claim 15, wherein:
the second network node comprises a PCF of a mobile communication system, and
the method further comprises updating a PCC (Policy and Charging Control) rule based on the received QoS policy assistance information.

17. The method of claim 15, wherein:
the first network node comprises a NWDAF of a mobile communication system, and
sending the consumer request comprises invoking a service operation for analytics subscription or analytics information request provided by the NWDAF.

18. The method of claim 17, wherein invoking the service operation comprises:
invoking the service operation with at least one of Analytics ID, at least one QoS parameter set, a list of candidate values for individual QoS parameters, analytics filter information, Analytics target period, or Target of Analytics Reporting.

19. The method of claim 18, wherein the Analytics ID is QoS Policy Assistance Information or QoS and Policy Assistance.

20. The method of claim 18, wherein invoking the service operation comprises:
invoking the service operation further with at least one of a service experience KPI, a reference value of the service experience KPI, a preferred order of results, a maximum number of objects, or a preferred level of accuracy of the analytics.

21. The method of claim 20, wherein the reference value of the service experience KPI is expressed as at least one of a requested QoE, Thresholds for service experience KPI, or a target service experience.

22. The method of claim 18, wherein each of the at least one QoS parameter set comprises a predefined 5QI value or QoS characteristics attributes constituting 5QI.
